(19) United States
(12) Patent Application Publication
(10) Pub. No.: US 2006/0168138 A1
(43) Pub. Date: Jul. 27, 2006

(54) Resource providing system, mediating agent, resource providing method and computer program product

(75) Inventor: Satoshi Deishi, Ibaraki-shi (JP)

Correspondence Address: SIDLEY AUSTIN LLP, 717 NORTH HARWOOD, SUITE 3400, DALLAS, TX, 75201, US

(73) Assignee: KONICA MINOLTA HOLDINGS, INC.

(21) Appl. No.: 11/300,253

(22) Filed: Dec. 14, 2005

(30) Foreign Application Priority Data
Dec. 20, 2004 (JP) JP2004-368204

(51) Int. Cl. G06F 15/16

(52) U.S. Cl. 709/219

(57) ABSTRACT

A resource providing system is provided with a user agent, an interlayer agent, and a resource agent. The user agent includes a file acquisition processing portion that makes a request to the interlayer agent for a file desired by the user. The interlayer agent includes a file relay portion that determines the resource agent that manages the file requested by the user agent, and gives an instruction to that resource agent that the file should be sent to the user. The resource agent includes a file transmission portion that transmits that file to the user agent. Thus, it is possible to simply perform a search for a resource desired by a user from among resources distributed on a plurality of servers or the like.

This application is based on Japanese Patent Application No. 2004-368204 filed on Dec. 20, 2004, the contents of which are hereby incorporated by reference.

### BACKGROUND OF THE INVENTION

1. Field of the Invention

The present invention relates to a system and a method for providing a resource to a user via a network.

2. Description of the Related Art

In recent years, it has become possible to easily and cheaply construct systems that utilize a network, and to easily share resources such as hardware, software, or data via a network with a plurality of terminal apparatuses such as personal computers. For example, methods have been realized to use a file saved on a file server by downloading the file to a plurality of terminal apparatuses via a network.

With a search engine used via the internet (for example, “Google” of Google Co.), it is possible to search for information including keywords specified by a user from among a very large amount of information that an agent has gathered from a large number of servers on the Internet.

“Agent” means a function to carry out processing by independently performing a judgment according to circumstances or instructions. For example, agents such as those disclosed in the following patent publications have been proposed.

In a remote file system disclosed in Japanese Unexamined Patent Publication No. 8-194639, a remote file access agent is provided in each control unit constituting a parallel system. Thus, even when many remote file access requests have been issued at the same time from external systems, distributed processing of the requests is performed by the remote file access agents, and thus it is possible to prevent a decrease in the remote file access processing speed of the entire parallel system.

According to a distributed file system disclosed in Japanese Unexamined Patent Publication No. 2001-75858, real-time applications and simultaneous reading from/writing to a file are supported using a plurality of agents.

According to a system disclosed in Japanese Unexamined Patent Publication No. 2003-223286, a plurality of copy unit agents respectively manage copy units, and a file system agent manages the copy unit agent of the same user. The copy unit agent has a copy unit replication function, and autonomously detects the degree of multiplexing of the copy units via a network. When the degree of multiplexing is inadequate, the copy unit agent makes a replication request to another storage apparatus. With this sort of configuration, it is possible to have the storage apparatus function autonomously.

However, when the number of file servers increases, there may be instances when the user does not know which file server his/her desired file is saved on, and cannot proficiently find the file.

Also, the server processing load and the network traffic increase when using the sort of search engine described above. Accordingly, such a search engine is not well-suited to searching for resources such as shared files in small-scale network systems such as those introduced into offices. Even when using agents such as those disclosed in the above patent publications, it is ultimately not possible to solve the problems stated above.

### SUMMARY OF THE INVENTION

In view of such problems, it is an object of the present invention to make it possible to search for a user's desired resource from among resources distributed on a plurality of servers or the like, while making the network traffic and the search processing load lighter than with the conventional technology.

According to one aspect of the present invention, a resource providing system provides a resource to a user via a network. The resource providing system includes a terminal apparatus that is operated by the user, a plurality of resource management servers that manage a resource, and a mediating server that executes processing for mediating between the terminal apparatus and the resource management server, wherein the terminal apparatus has a resource usage requesting portion that makes a request to the mediating server for use of a resource desired by the user, the mediating server has a management origin determining portion that determines the resource management server that manages the resource requested from the terminal apparatus, and an instruction portion that gives an instruction to the resource management server determined by the management origin determining portion to execute processing in order to make it possible for the user to use the resource requested from the terminal apparatus, and the resource management server has a resource providing processing portion that executes processing in order to allow the user to use the resource involved in the instruction.

In the present invention, “resources” means hardware, software, data, and the like that constitute a computer. For example, resources include memory, printing devices, computational programs, files, and the like.

According to the present invention, it is possible to search for a user's desired resource from among resources distributed on a plurality of servers or the like, while making the network traffic and the search processing load lighter than with the conventional technology.

These and other characteristics and objects of the present invention will become more apparent by the following descriptions of preferred embodiments with reference to drawings.

### BRIEF DESCRIPTION OF THE DRAWINGS

FIG. 1 is a diagram that shows an example of the configuration of an entire resource providing system.

FIG. 2 is a diagram that shows an example of the linkage of user agents, interlayer agents, and resource agents.

FIG. 3 is a diagram that shows an example of a functional configuration of a user agent, an interlayer agent, and a resource agent.

FIG. 4 is a diagram that shows an example of a file information database.

FIG. 5 is a flowchart that illustrates an example of a flow of processing of a user agent, an interlayer agent, and a resource agent when providing a file desired by a user.

FIG. 6 is a flowchart that illustrates an example of a flow of processing of a user agent, an interlayer agent, and a resource agent when providing a file desired by a user.

FIG. 7 is a diagram that shows an example of a search conditions input screen.

FIG. 8 is a diagram that shows an example of a search results screen.

FIG. 9 is a flowchart that illustrates an example of a flow of providability judgment processing.

FIG. 10 is a diagram that shows an example of a functional configuration of a resource agent and a file information management agent.

### DESCRIPTION OF THE PREFERRED EMBODIMENTS

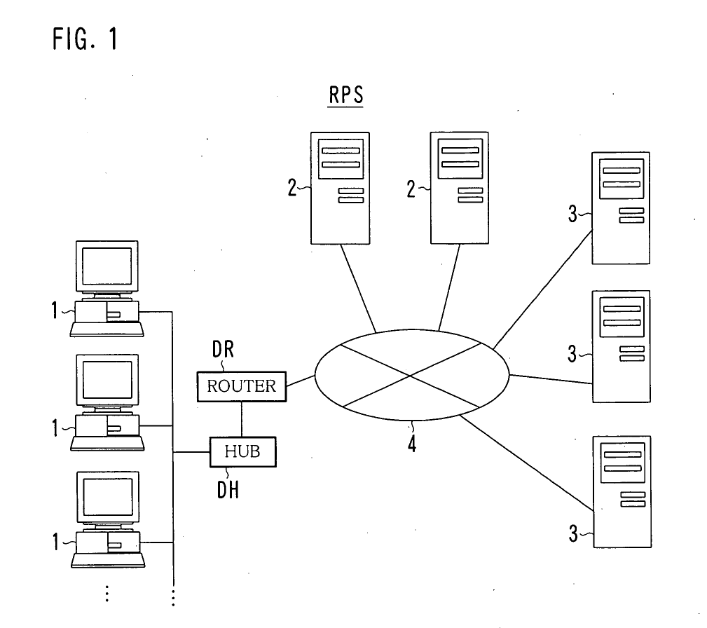

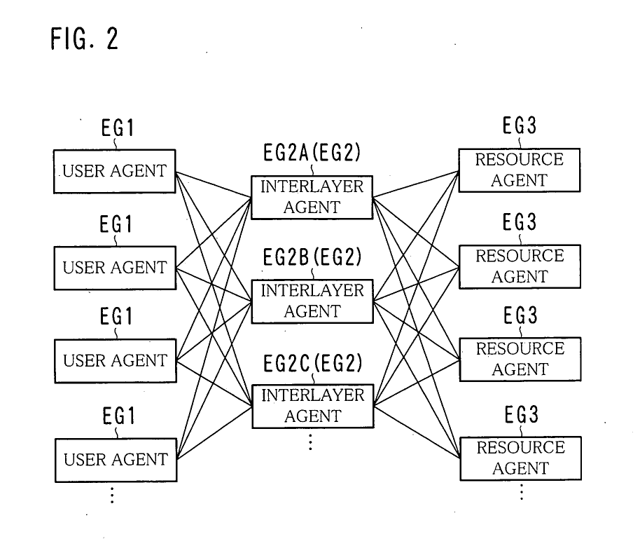

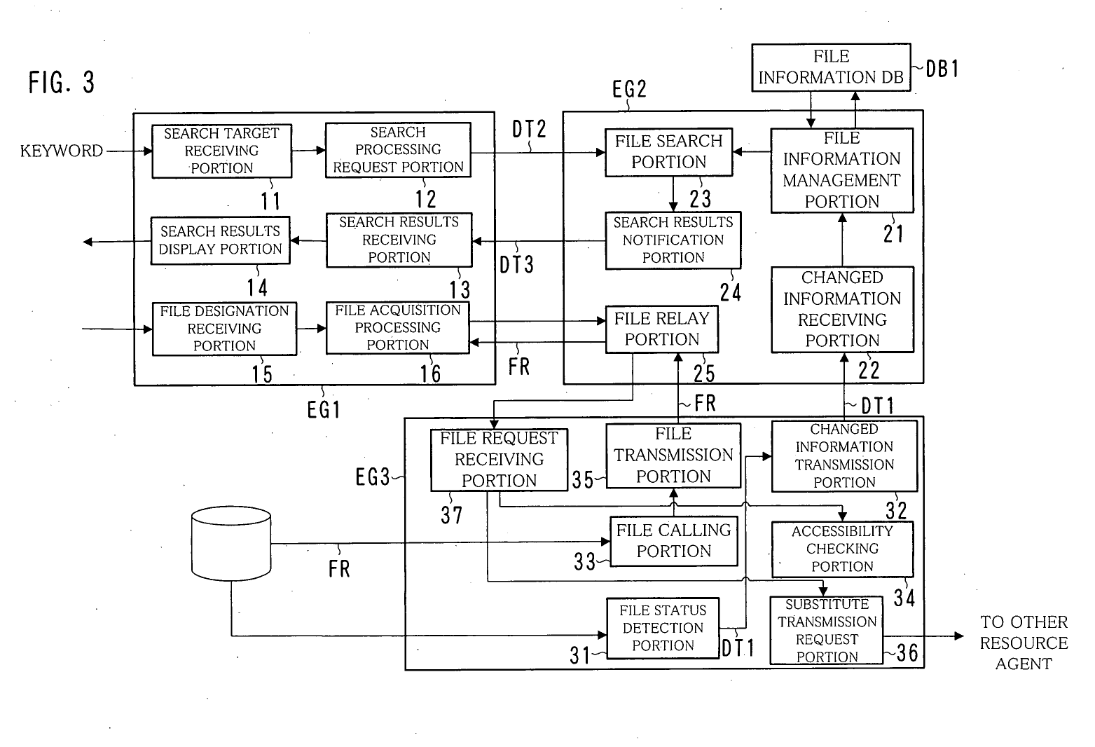

FIG. 1 is a diagram that shows an example of the configuration of an entire resource providing system RPS. FIG. 2 is a diagram that shows an example of the linkage of a user agent EG1, an interlayer agent EG2, and a resource agent EG3. FIG. 3 is a diagram that shows an example of the functional configuration of the user agent EG1, the interlayer agent EG2, and the resource agent EG3.

As shown in FIG. 1, the resource providing system RPS according to the present invention is configured from user terminal apparatuses 1, intermediate servers 2, resource management servers 3, and communication lines 4. The user terminal apparatuses 1, the intermediate servers 2, and the resource management servers 3 are connected to each other via the communications lines 4 and various apparatuses.

The Internet, a public line, a private line, a LAN, or the like is used as the communications line 4. The user terminal apparatus 1 is connected to the communications line 4 by a hub DH, a router DR, and the like. The user terminal apparatus 1 can connect to an access point by dialing up with a modem, a TA (terminal adapter), or the like.

A personal computer, a workstation, a PDA (personal digital assistant), a mobile telephone terminal or the like can be used as the user terminal apparatus 1. A user can have a resource managed with the resource management server 3 provided by operating the user's own user terminal apparatus 1.

The resource management server 3 manages a resource, and provides that resource to a user. The following is an explanation of a case in which a file FR saved on a storage medium such as a hard disk is the resource, that is, a case in which a data resource is the resource itself. A server such as a so-called file server having a file-sharing function or an FTP server having a function to transfer a file by FTP (file transfer protocol) can be used as the resource management server 3.

A theme is given to the file FR according to its intended use, contents, the person who will use it, and the like. For example, a theme such as intra-company meeting, customer presentation, product X specifications, company prospectus, project proposal, sales department, development group, or the like is given to the file FR. The theme can be assigned by the author, the manager, or the owner of the file FR. In the present embodiment, a theme is assigned by selecting from among a plurality of themes that are prepared in advance. A plurality of themes may be assigned to one file FR. Other than themes, author identification information (user name or user ID) and information that indicates an email address or the like are associated with the file FR.

The intermediate server 2 is a server for more smoothly providing resources from the resource management server 3 to the user's user terminal apparatus 1, by performing processes that manage information relating to the file FR managed by the resource management server 3, that search for the file FR desired by the user, and the like.

A computer program for implementing the user agent EG1 is installed on the user terminal apparatus 1. A computer program for implementing the interlayer agent EG2 is installed on the intermediate server 2. A computer program for implementing the resource agent EG3 is installed on the resource management server 3. These agents are linked with the operating system and hardware, detect a request from a user or another agent and perform an independent judgment, and execute processing in response to that request.

As shown in FIG. 2, the user agent EG1 and the interlayer agent EG2 are linked to each other and execute a predetermined process, and the interlayer agent EG2 and the resource agent EG3 are linked to each other and execute a predetermined process.

One interlayer agent EG2 is provided for each theme of the file FR. Below, interlayer agents EG2 provided for “theme A”, “theme B”, etc. may be stated by respectively differentiating them as “interlayer agent EG2A”, interlayer agent EG2B”, etc.

As shown in FIG. 3, the user agent EG1 is configured for example from a search target receiving portion 11, a search processing request portion 12, a search results receiving portion 13, a search results display portion 14, a file designation receiving portion 15, and a file acquisition processing portion 16.

The interlayer agent EG2 is configured for example from a file information management portion 21, a changed information receiving portion 22, a file search portion 23, a search results notification portion 24, and a file relay portion 25.

The resource agent EG3 is configured for example from a file status detection portion 31, a changed information transmission portion 32, a file calling portion 33, an accessibility checking portion 34, a file transmission portion 35, a substitute transmission requesting portion 36, and a file request receiving portion 37.

The following is an explanation of the processing of the user agent EG1, the interlayer agent EG2, and the resource agent EG3 in each portion, divided roughly into processing for the purpose of file management and processing for the purpose of providing a file to a user.

Processing for File Management

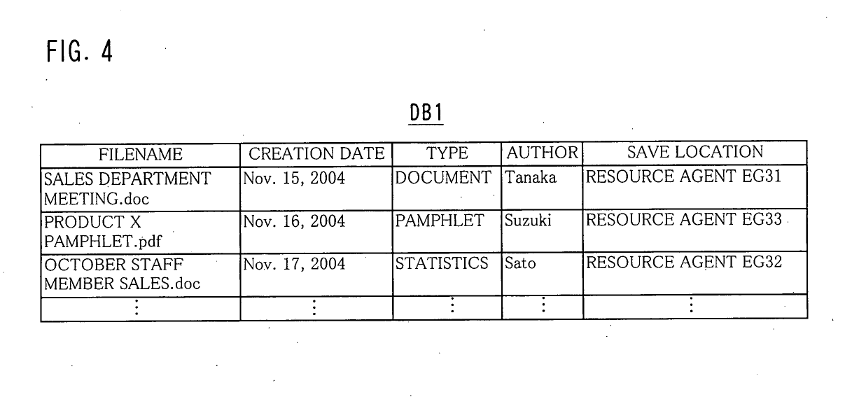

FIG. 4 is a diagram that shows an example of a file information database DB1.

In FIG. 3, the file status detection portion 31 of the resource agent EG3 detects a change in the status of the file FR saved on the resource management server 3 on which that resource agent EG3 is operating. For example, the file status detection portion 31 detects the saving of a new file FR on a storage medium such as a hard disk, changes in the filename or contents of the file FR in response to user operation or the like, or deletion of the file FR.

When a change in the status of the file FR has been detected by the file status detection portion 31, the changed information transmission portion 32 transmits file change information DT1 that indicates the contents of that change, identifying information for that file FR (for example, the filename), and the like to the interlayer agent EG2 that corresponds to the theme of the file FR involved in that change.

In the interlayer agent EG2, the changed information receiving portion 22 receives the file change information DT1 that has been transmitted from the resource agent EG3.

The file information management portion 21 performs management of information of the file FR that corresponds to the theme handled by that interlayer agent EG2 with, for example, the following sort of method.

A file information database DB1 as shown in FIG. 4 is provided in advance on a storage medium (such as a hard disk) of the intermediate server 2 on which that interlayer agent EG2 is installed.

One record is provided in the file information database DB1 for each file FR. “Filename”, “creation date”, and “author” respectively mean a filename for the purpose of identifying that file FR, the date and time that the file FR was created, and the name of the user who created the file FR. “Save location” means the resource agent EG3 of the resource management server 3 where the file FR is saved. “Type” means the type of the contents of the file FR, and can be decided by the author or a manager as desired. A configuration may also be adopted in which a plurality of choices is prepared in advance, and it is possible to determine the file type from among those choices.

The file information management portion 21 updates the contents of the file information database DB1 based on the file change information DT1 that has been transmitted from the resource agent EG3. For example, when information relating to the newly saved file FR is indicated in that file change information DT1, a new record is created in the file information database DB1, storing information related to that file FR. When file change information DT1 indicating that the file FR has been deleted has been transmitted, records corresponding to that file FR are deleted from the file information database DB1.

In this manner, information relating to the file FR that belongs to the handled theme is managed in each interlayer agent EG2.

Processing For Providing File To User

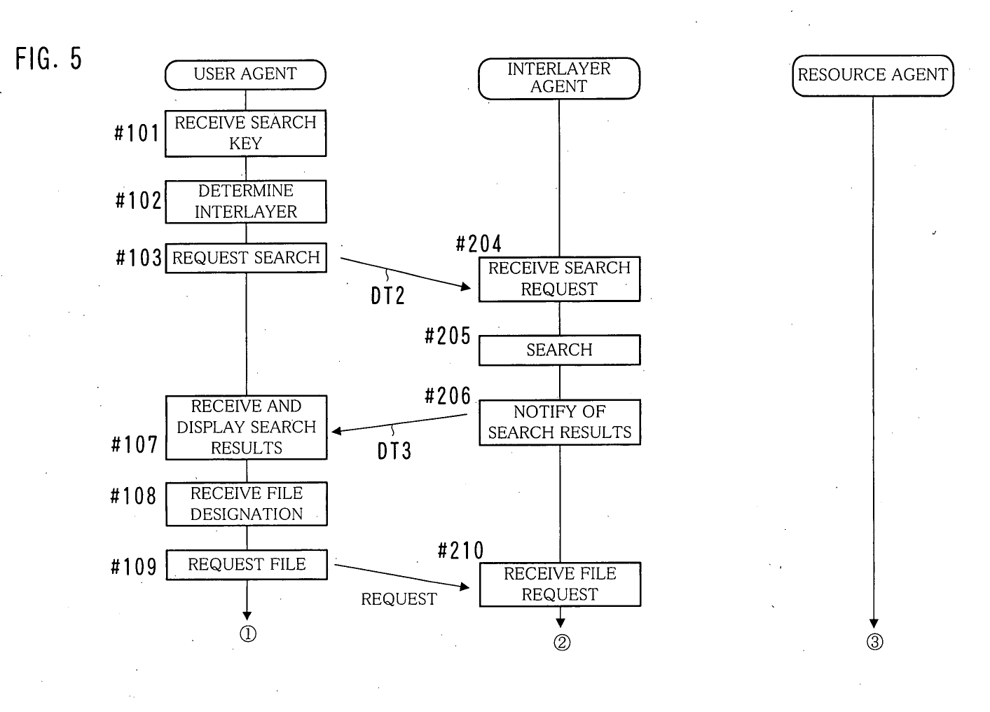

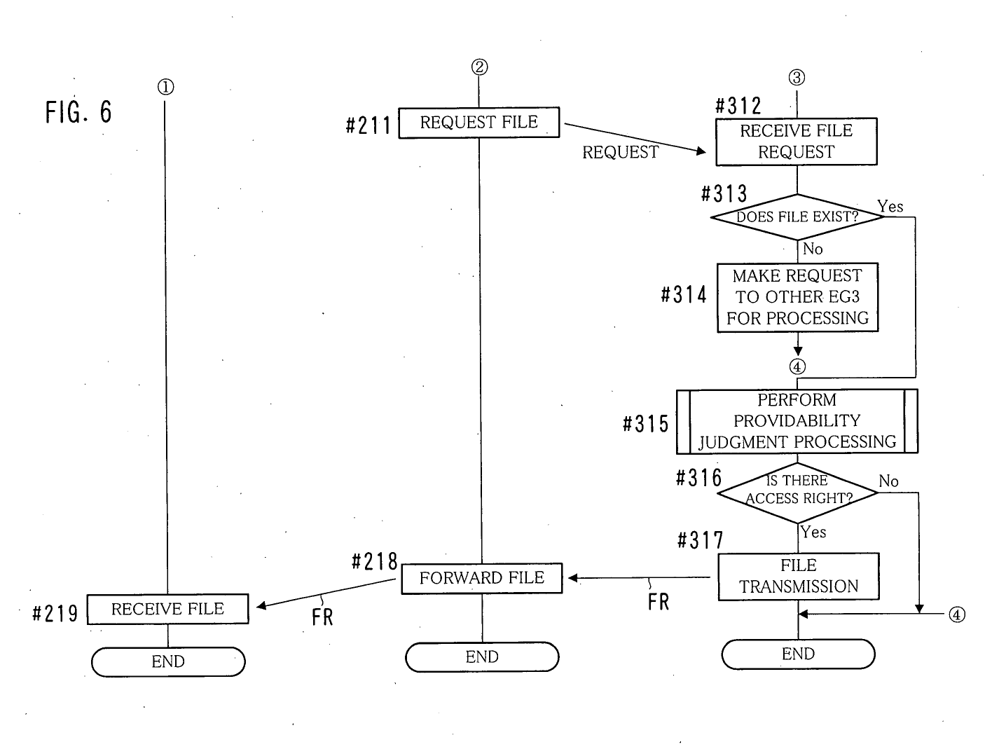

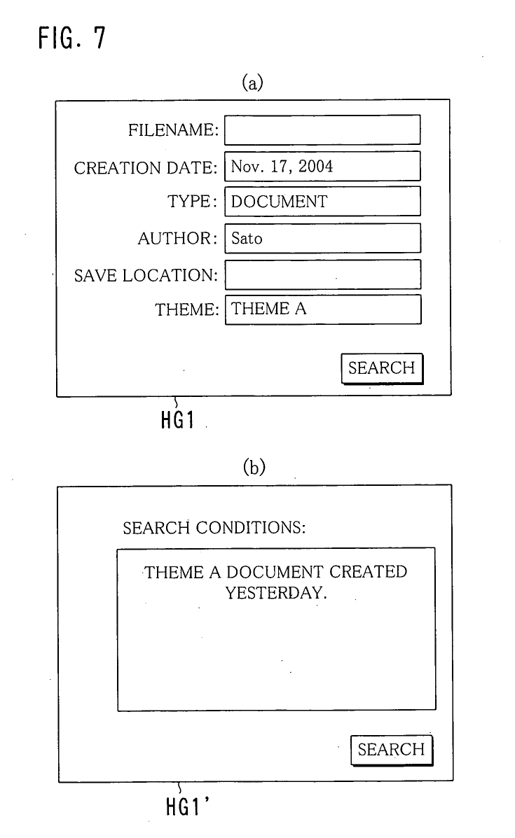

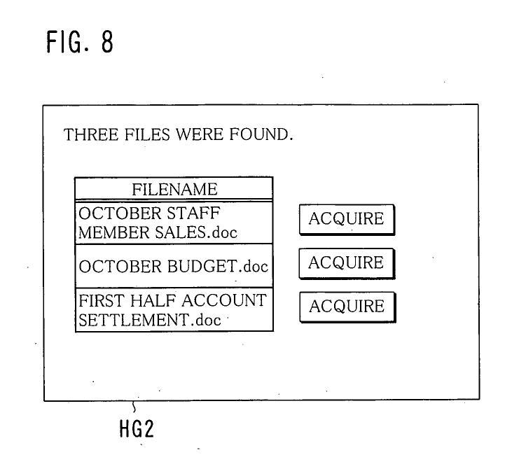

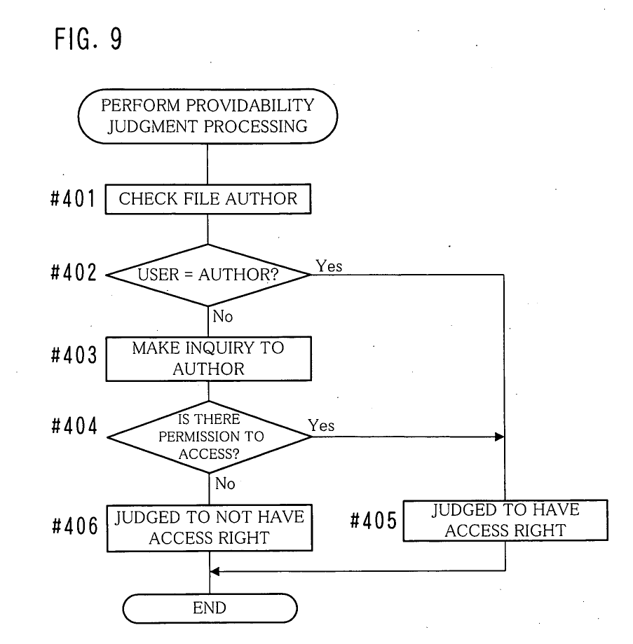

FIG. 5 and FIG. 6 are flowcharts that illustrate an example of the flow of processing in the user agent EG1, the interlayer agent EG2, and the resource agent EG3 when providing the file FR desired by the user. FIG. 7 is a diagram that shows an example of search conditions input screens HG1 and HG1′. FIG. 8 is a diagram that shows an example of a search results screen HG2, and FIG. 9 is a flowchart that illustrates an example of the flow of providability judgment processing.

The search target receiving portion 11 of the user agent EG1 receives keywords (search conditions) for searching for the file FR that the user desires. The search processing request portion 12 makes a request to the interlayer agent EG2 that search processing be executed based on the received keywords. The search results receiving portion 13 receives the search results from the interlayer agent EG2, and the search results display portion 14 displays those search results.

The file designation receiving portion 15 receives a file FR designation from the user, who has seen the search results. The file acquisition processing portion 16 performs processing to acquire that file FR from the save source.

The file search portion 23 of the interlayer agent EG2 searches for a file FR that satisfies the search conditions according to the request from the user agent EG1. The search results notification portion 24 notifies the request source user agent EG1 of the search results. The file relay portion 25 acquires the file FR requested by the user agent EG1 from the resource agent EG3, and performs processing to relay that file FR to that user agent EG1.

The file calling portion 33 of the resource agent EG3 calls the file FR requested by the user via the interlayer agent EG2, and the accessibility checking portion 34 checks whether or not the request source user may be allowed to use that file FR. When a check result has been obtained that usage of the file FR may be allowed, the file transmission portion 35 performs processing to transmit that file FR to the request source user.

The contents of the processing for providing the file FR to the user will be described in more detail with reference to the flowcharts in FIG. 5 and FIG. 6.

The user may download and use a desired file FR from the resource management server 3 by operating the user terminal apparatus 1. When the user inputs a predetermined command to the user terminal apparatus 1, the search target receiving portion 11 of the user agent EG1 of that user terminal apparatus 1 displays a search conditions input screen HG1 for inputting search conditions on a monitor, as shown in FIG. 7(a).

Here, the user enters keywords related to his/her desired file FR. If the filename and the resource agent EG3 that is the save location of the desired file FR are known, then these are input. If the save location and the filename are not known, the theme, author, creation date, type, and the like of the desired file FR are input to the extent that they are known. After input, a “search” button is pressed. These keywords are used afterwards as search conditions in the interlayer agent EG2.

Also, a configuration may be adopted wherein the search conditions input screen HG1′ as shown in FIG. 7(b) is displayed, and it is possible to input in free text or natural text format, as in “theme A document created yesterday”. In this case, search conditions relating to each item may be extracted from the input contents using a publicly known natural text search system. If “theme A document created yesterday” was input on Nov. 18, 2004, then the keywords “Nov. 17, 2004”, “document” and “theme A” will be extracted as search conditions for each of the items creation date, type and theme, respectively.

A configuration may also be adopted in which, when a search condition (keyword) relating to the author has not been input, the user who is operating the user terminal apparatus 1 (that is, the user who is logged in to the user terminal apparatus 1) is added as a search condition relating to the author. Also, all authors may be added as search conditions (that is, setting no limiting conditions relating to the author).

When the search target receiving portion 11 receives the search conditions that have been input by the user (#101 in FIG. 5), the search process request portion 12 determines the interlayer agent EG2 that handles the theme indicated in the search conditions based on the file information database DB1 in FIG. 4 (#102), and performs a search request by transmitting those search conditions to that interlayer agent EG2 as the search condition information DT2 (#103). For example, when “theme A” is indicated in the search conditions, a search request is made to the interlayer agent EG2A. However, when a theme is not designated in the search conditions, a search request is made to all of the interlayer agents EG2.

In the interlayer agent EG2, when the search condition information DT2 is received (#204), the file search portion 23 searches in the file information database DB1 for a file FR that satisfies the search conditions indicated in the search condition information DT2 (#205). For example, when search conditions as in FIG. 7(a) have been input, the file search portion 23 searches for a file FR that is a document created by Mr. Sato on Nov. 17, 2004. Then, the search results notification portion 24 transmits those search results to the user agent EG1 that is the input source of the search conditions as the search results information DT3 (#206).

When the search results receiving portion 13 of the user agent EG1 receives the search results information DT3, the search results display portion 14 displays the search results indicated in that search results information DT3 on a monitor as the search results screen HG2, as shown in FIG. 8 (#107).

Here, the user designates his/her desired file FR by pressing an “acquire” button on the right side of that screen. Then, the file designation receiving portion 15 receives the designation of that file FR (#108), and the file acquisition processing portion 16 makes a request to the interlayer agent EG2 for that file to be transmitted to the user terminal apparatus 1 (#109).

When a request for transmission of the file FR is received (#210), the file relay portion 25 of the interlayer agent EG2 performs processing to acquire that file FR from the resource agent EG3 and provide it to the user agent EG1 of the request source. That is, processing is performed to relay the file FR from the resource agent EG3 to the user agent EG1. Such processing is performed in the manner described below.

First, the resource agent EG3 of the resource management server 3 where the requested file FR is saved is determined by referring to the file information database DB1 of FIG. 4, and a request is made to the resource agent EG3 to transmit that file FR (#211 in FIG. 6). At this time, the request source user is also notified.

In the resource agent EG3, when the request from the user to transmit the file FR is received via the interlayer agent EG2 (#312), the file request receiving portion 37 checks whether or not that file FR is saved on the resource management server 3 of that resource agent EG3. (#313). If the file is saved (Yes in #313), then the accessibility check portion 34 checks whether or not the request source user has an access right for that file FR, for example with the procedure as shown in FIG. 9 (#315).

Information relating to that file FR is called, and a check is performed of whether or not the request source user is the author of that file FR (#401). If it is judged as a result of that check that the request source user is the author (Yes in #402), then it is judged that the request source user has an access right (#405).

When it has been judged that the request source user is not the author (No in #402), an inquiry as to whether or not that file FR may be provided to the request source user is performed by displaying a message on the monitor of the user terminal apparatus 1 of the author or by transmitting electronic mail to an electronic mail address of the author (#403). The author inputs their permission or lack thereof by, for example, operating his/her own user terminal apparatus 1. When a result that the file may be provided (permission) has been obtained from the author (Yes in #404), it is judged that the user has an access right (#405). When permission has not been obtained (No in #404), it is judged that the user does not have an access right (#406).

In the example in FIG. 9, the presence or absence of an access right was judged based on whether or not the request source user was the author of the file FR. However, it is also possible to provide in advance a list indicating the users who have been given access rights to each file FR, and judge the presence or absence of an access right based on that list. It is also possible to judge the existence of access rights without performing an inquiry to the author (#403, #404).

Returning to FIG. 6, when it has been judged that there is an access right (Yes in #316), the file calling portion 33 calls the file FR involved in the request, and the file transmission portion 35 transmits the file FR to the interlayer agent EG2 that relayed the request (#317). When it has been judged that there is not an access right (No in #316), transmission of the file FR is denied. In this case, the user may be notified with a message via the interlayer agent EG2 that transmission is denied.

There may be cases in which the file FR involved in the request is not saved on the resource management server 3 of the resource agent EG3. This is because the file FR may have been deleted or moved to another resource agent EG3 in the interval from the time that the user is notified of the file search results until the time that the user designates a file. In this way, when the file FR involved in the request is not saved (No in #313), the substitute transmission request portion 36 makes a request to another resource agent EG3 to transmit the file FR involved in the request (#314). That is, the request from the user for the file FR is transferred as-is to another resource agent EG3, and a request is made to substitute the transmission processing.

When there is a plurality of other resource agents EG3, a request is made to an adjacent resource agent EG3. For example, a control signal (for example, ping) is sent to all of the other resource agents EG3, and a request is made to the resource agent EG3 with the shortest response time, i.e., the resource agent EG3 with the shortest network distance. Also, a request may be made to the resource agent EG3 with the smallest number of intermediate nodes.

The other resource agent EG3 that has received the request, same as in the case of the resource agent EG3 that initially received a request, executes the processing of Steps #313 to #317. That is, when the file FR involved in the request is saved, a check for an access right is performed, and that file FR is transmitted to the interlayer agent EG2 that relayed the request (#315 to #317). When the file FR involved in the request is not saved, a request is made to another resource agent EG3 (#314). However, a request is not made to the resource agent EG3 that has once received a request for that file FR. When the result of repeated requests is that the file FR involved in the request was not found in any of the resource agents EG3, the user agent EG1 is notified with a message to that effect via the interlayer agent EG2.

In the interlayer agent EG2, the file relay portion 25 forwards the file FR that has been transmitted from the resource agent EG3 to the user agent EG1 of the request source user (#218).

By doing so, the file FR desired by the user is received (downloaded) by the user terminal apparatus 1 of the user agent EG1 (#219). The user can use this file FR by opening it with application software, for example.

According to the present embodiment, it is possible to search for the user's desired resource from among resources distributed on a plurality of resource management servers 3, while making the network traffic and the search processing load lighter than with the conventional technology. That is, a plurality of interlayer agents EG2 are provided, and each interlayer agent EG2 manages only the information for resources corresponding to assigned themes. Thus, it is possible to organize the traffic of data for the purpose of searching or providing resources, and it is possible to lighten network traffic and the search processing load.

Also, according to the present embodiment, because the resource itself, i.e., the file FR, is always handled via an agent, the save location of the file FR is hidden. Thus, the user cannot directly access the file FR as in the conventional technology, and it is therefore possible to prevent unauthorized removal of the file FR or rewriting of security information.

Because it appears to the user as if all of the resources are virtually saved in one location, the troublesome operation of changing search locations according to the desired resource does not have to be performed.

The user agent EG1 gathers only information relating to the resource desired by the user. Thus, even if the processing ability of the user terminal apparatus 1 where the user agent EG1 is installed is low, it is possible to proficiently handle a very large amount of information.

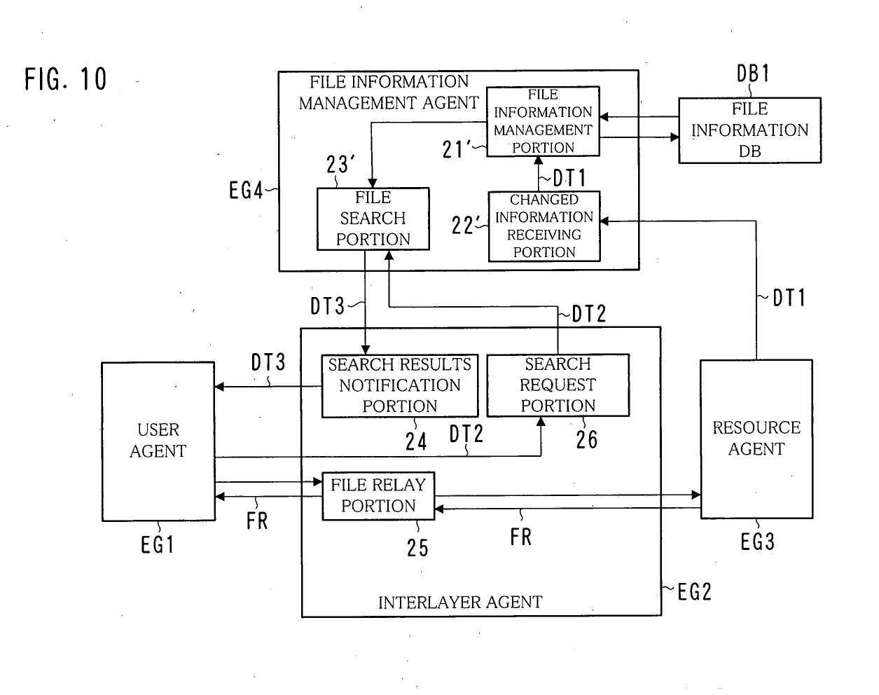

FIG. 10 is a diagram that shows an example of the functional configuration of the resource agent EG3 and a file information management agent EG4.

In the present embodiment, one interlayer agent EG2 was provided for each theme, but a configuration may also be adopted in which one interlayer agent EG2 is shared by a plurality of themes.

In the present embodiment, one interlayer agent EG2 was provided for each intermediate server 2, but a plurality of interlayer agents EG2 may also be provided. The interlayer agent EG2 may also be provided in the user terminal apparatus 1 or the resource management server 3. Also, the interlayer agent EG2 may be provided in a preexisting proxy server, web server, gateway, or the like.

A configuration may also be adopted in which an agent is provided that manages information relating to the file FR (hereinafter, referred to as a “file information management agent EG4”), and a part of the function of the interlayer agent EG2 is realized by the file information management agent EG4.

For example, as shown in FIG. 10, a file information management portion 21′, a changed information receiving portion 22′, and a file search portion 23′ are provided in the file information management agent EG4 that respectively correspond to the file information management portion 21, the changed information receiving portion 22, and the file search portion 23 of the interlayer agent EG2 that was illustrated in FIG. 3. The file information database DB1 (see FIG. 4) is also provided in the computer in which the file information management agent EG4 is installed.

When a search request is received for the file FR along with the search condition information DT2 from the user agent EG1, the search request portion 26 of the interlayer agent EG2 makes a request to the file information management agent EG4 to search for a file FR that satisfies the search conditions indicated in the search condition information DT2.

The file search portion 23′ of the file information management agent EG4 searches for a file FR that satisfies the search conditions by referring to the file information database DB1, as previously illustrated in Step #205 of FIG. 5, and notifies the interlayer agent EG2 of the search results.

Then, the search results notification portion 24 of the interlayer agent EG2 notifies the request source user agent EG1 of the search results.

The file change information DT1 of the file FR managed by the file information management agent EG4 is received by the changed information receiving portion 22′ of the file information management agent EG4. A configuration may also be adopted in which the file change information DT1 is sent to the file information management agent EG4 via the interlayer agent EG2.

In the present embodiment, an example was described in which files, i.e. data assets, are managed as resources in each resource agent EG3, but the present invention may also be applied to a case involving other resources. For example, a configuration may also be adopted in which a resource agent EG3 is installed for each MFP (multi-function peripheral) provided in the resource providing system RPS, and MFP hardware assets, software assets, and the like are managed.

Also, the configuration of all or a part of the resource providing system RPS, the user agent EG1, the interlayer agent EG2, the resource agent EG3, the file information management agent EG4, the contents of processing, the processing procedure, the resource search method, the screen configuration, and the like may be appropriately modified in accordance with the subject matter of the present invention.

The present invention is particularly well-suited for effectively using a resource that has been distributed to a plurality of servers.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A resource providing system that provides a resource to a user via a network, comprising:
a terminal apparatus that is operated by the user;
a plurality of resource management servers that manage a resource; and
a mediating server that executes processing for mediating between the terminal apparatus and the resource management server, wherein
the terminal apparatus has a resource usage requesting portion that makes a request to the mediating server for use of a resource desired by the user,
the mediating server has a management origin determining portion that determines the resource management server that manages the resource requested from the terminal apparatus, and an instruction portion that gives an instruction to the resource management server determined by the management origin determining portion to execute processing in order to make it possible for the user to use the resource requested from the terminal apparatus, and
the resource management server has a resource providing processing portion that executes processing in order to allow the user to use the resource involved in the instruction.

2. The resource providing system according to claim 1, wherein the resource providing processing portion transfers a file that is the resource involved in the instruction to the terminal apparatus operated by the user in order to make it possible for the user to use the file.

3. A resource providing system that provides a resource to a user via a network, comprising:
a user agent that executes processing based on a command of the user;
a plurality of resource agents that manage a resource; and
a mediating agent that executes processing for mediating between the user agent and the resource agent, wherein
the user agent has a resource usage requesting portion that makes a request to the mediating agent for use of a resource desired by the user,
the mediating agent has an agent determining portion that determines the resource agent that manages the resource requested from the user agent, and an instruction portion that gives an instruction to the resource agent determined by the agent determining portion to execute processing in order to make it possible for the user to use the resource requested from the user agent, and
the resource agent has a resource providing processing portion that executes processing for allowing the user to use the resource involved in the instruction.

4. The resource providing system according to claim 3, wherein the resource providing processing portion transfers a file that is the resource involved in the instruction to the user agent for which the user desires the resource to execute the processing for allowing the user to use the resource.

5. The resource providing system according to claim 3, wherein the mediating agent has a resource information managing portion that manages resource information that indicates what sort of resource is managed in the resource agent, and
the agent determining portion determines the resource agent that manages the resource requested from the user agent based on the resource information.

6. The resource providing system according to claim 5, wherein the resource agent manages a file as a resource,
the mediating agent is provided for each one or for a plurality of themes relating to the contents of the file,
the resource information managing portion of the mediating agent manages the resource information involved in the theme that corresponds to the mediating agent, and
the resource usage requesting portion of the user agent makes a request for use of a file desired by the user to the mediating agent corresponding to the theme of the file.

7. The resource providing system according to claim 6, wherein the resource agent has a changed information transmitting portion that transmits changed information relating to a change of the file that the resource agent manages to the mediating agent that corresponds to the theme of the file, and
the resource information managing portion of the mediating agent updates the resource information based on the changed information that has been transmitted from the mediating agent.

8. The resource providing system according to claim 3, wherein when an author of the resource involved in the instruction is the user that made the request or when permission to provide the resource has been obtained from the author, the resource providing processing portion of the resource agent executes processing to allow use of the resource.

9. The resource providing system according to claim 3, wherein the mediating agent has a searching portion that searches for a resource corresponding to keywords designated by the user agent, and
the user agent has a displaying portion that displays a view of the resources searched by the searching portion.

10. The resource providing system according to claim 9, wherein the searching portion searches for a file corresponding to the keywords,
the displaying portion displays, as the view, a view of the files searched by the searching portion,
the resource usage requesting portion makes a request for use of a file desired by the user from among the view, and
the resource providing processing portion transfers a file that is the resource involved in the instruction to the user agent for which the user desires the resource to execute the processing for allowing the user to use the resource.

11. A mediating agent that executes mediating processing for providing a user with a resource managed by a resource agent via a network, the mediating agent comprising:
a request receiving portion that receives a request for use of a resource from the user;
an agent determining portion that determines the resource agent that manages the resource involved in the request; and
a usage processing request portion that gives an instruction to the resource agent determined by the agent determining portion to execute processing in order to make it possible for the user to use the resource involved in the request.

12. The mediating agent according to claim 11, further comprising a resource information managing portion that manages resource information on the resource managed in the resource agent, and
the agent determining portion determines the resource agent that manages the resource involved in the request based on the resource information.

13. The mediating agent according to claim 11, wherein the usage processing request portion gives, as the instruction, an instruction to transfer a file that is the resource involved in the request to a terminal apparatus of the user.

14. The mediating agent according to claim 12, further comprising a searching portion that searches for a resource corresponding to keywords designated by the user, and
a view presenting portion that executes processing for presenting to the user a view of the resources searched by the searching portion, wherein
the request receiving portion receives, as the request, a request for use of the resource that is selected from the view by the user.

15. The mediating agent according to claim 14, wherein
the searching portion searches for a file corresponding to the keywords, and
the usage processing request portion gives, as the instruction, an instruction to transfer a file that is the resource involved in the request to a terminal apparatus of the user.

16. A method for providing a user with a resource managed by a resource agent via a network, the method comprising:
receiving a request for use of a resource from the user;
determining the resource agent that manages the resource involved in the request; and
giving an instruction to the determined resource agent to execute processing in order to make it possible for the user to use the resource involved in the request.

17. The method according to claim 16, further comprising receiving, as the request, a request for use of a file, and
giving, as the instruction, an instruction to transfer a file involved in the request to a terminal apparatus of the user.

18. The method according to claim 16, further comprising searching for a resource corresponding to keywords designated by the user, and
executing processing for presenting to the user a view of the searched resources.

19. The method according to claim 18, further comprising receiving, as the request, a request for use of the resource that is selected from the view by the user, and
giving, as the instruction, an instruction to the resource agent to transfer a file involved in the request to a terminal apparatus of the user.

20. A computer program product for use in a computer that provides a user with a resource managed by a resource agent via a network, the computer program product makes the computer execute the processes comprising:
receiving a request for use of a resource from the user;
determining the resource agent that manages the resource involved in the request; and
giving an instruction to the determined resource agent to execute processing in order to make it possible for the user to use the resource involved in the request.
